(19) United States
(12) Patent Application Publication
(10) Pub. No.: US 2025/0258633 A1
(43) Pub. Date: Aug. 14, 2025

(54) INFORMATION PROCESSING DEVICE, CONTROL METHOD OF THE SAME, STORAGE MEDIUM, AND PRINTING SYSTEM

(71) Applicant: CANON KABUSHIKI KAISHA, Tokyo (JP)

(72) Inventor: Chisei Sumita, Tokyo (JP)

(21) Appl. No.: 19/040,025

(22) Filed: Jan. 29, 2025

(30) Foreign Application Priority Data
Feb. 9, 2024 (JP) 2024-018846

(51) Int. Cl. G06F 3/12

(52) U.S. Cl. CPC G06F 3/1236; G06F 3/1204

(57) ABSTRACT

An information processing device obtains information of a printing device that can be registered in the information processing device by searching for printing device registered in a print server and a printing device connected to a local area network to which the information processing device is connected. If the information indicates that the printing device is capable of executing an identification action that assists a user in identifying the printing device, the device presents to the user an indication that the printing device corresponding to the information is capable of executing the identification action. The information processing device causes the printing device to execute the identification action in response to an instruction from the user and registers the printing device in the information processing device in response to an instruction from the user.

### BACKGROUND OF THE INVENTION

### Field of the Invention

The present invention relates to an information processing device, a method for controlling the information processing device, a storage medium, and a printing system.

### Description of the Related Art

Recent years have seen the widespread use of a cloud printing service in which an information processing device transmits a print job to a printing device via a cloud service. The information processing device can also transmit a print job to a printing device that is connected to a local area network to which the information processing device is connected. Japanese Patent Laid-Open No. 2012-133489 describes a method with which an information processing device searches for a printing device via a cloud service or in a local area. The printing device can be used by the information processing device when the printing device is registered in the information processing device.

### SUMMARY OF THE INVENTION

An aspect of the present invention provides a technology for assisting a user in identifying a printing device that can be registered in an information processing device. According to some embodiments, an information processing device comprising: an obtaining unit configured to obtain information of a printing device that can be registered in the information processing device by searching for one or more printing devices registered in a print server and one or more printing devices connected to a local area network to which the information processing device is connected; a presentation unit configured to, in a case where the information indicates that the printing device is capable of executing an identification action that assists a user in identifying the printing device, present to the user an indication that the printing device corresponding to the information is capable of executing the identification action; a request unit configured to cause the printing device to execute the identification action in response to an instruction from the user to cause the printing device selected from one or more presented printing devices to execute the identification action; and a registration unit configured to register the printing device in the information processing device in response to an instruction from the user to register the printing device in the information processing device is provided.

Further features of the present invention will become apparent from the following description of exemplary embodiments with reference to the attached drawings.

### BRIEF DESCRIPTION OF THE DRAWINGS

FIG. 1 is a block diagram showing an exemplary configuration of a printing system according to an embodiment.

FIG. 2 is a block diagram showing an exemplary hardware configuration of a printing device according to an embodiment.

FIG. 3 is a block diagram showing an exemplary hardware configuration of a computer according to an embodiment.

FIG. 4 is a schematic diagram showing an example of a setting screen according to an embodiment.

FIG. 5 is a sequence diagram showing an example of printing device registration actions according to an embodiment.

FIG. 6 is a schematic diagram showing an example of a packet according to an embodiment.

FIG. 7 is a schematic diagram showing an example of a packet according to an embodiment.

FIG. 8 is a schematic diagram showing an example of a packet according to an embodiment.

FIG. 9 is a schematic diagram showing an example of a packet according to an embodiment.

FIG. 10 is a flowchart showing an example of actions of the information processing device according to an embodiment.

FIG. 11 is a flowchart showing an example of actions of the information processing device according to an embodiment.

FIG. 12 is a flowchart showing an example of actions of the information processing device according to an embodiment.

FIG. 13 is a schematic diagram showing an example of a registration screen according to an embodiment.

FIG. 14 is a sequence diagram showing an example of actions for requesting an identification action according to an embodiment.

FIG. 15 is a sequence diagram showing an example of actions for requesting an identification action according to an embodiment.

FIG. 16 is a schematic diagram showing an example of a packet according to an embodiment.

FIG. 17 is a flowchart showing an example of actions of the printing device according to an embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

### Exemplary Configuration of Printing System

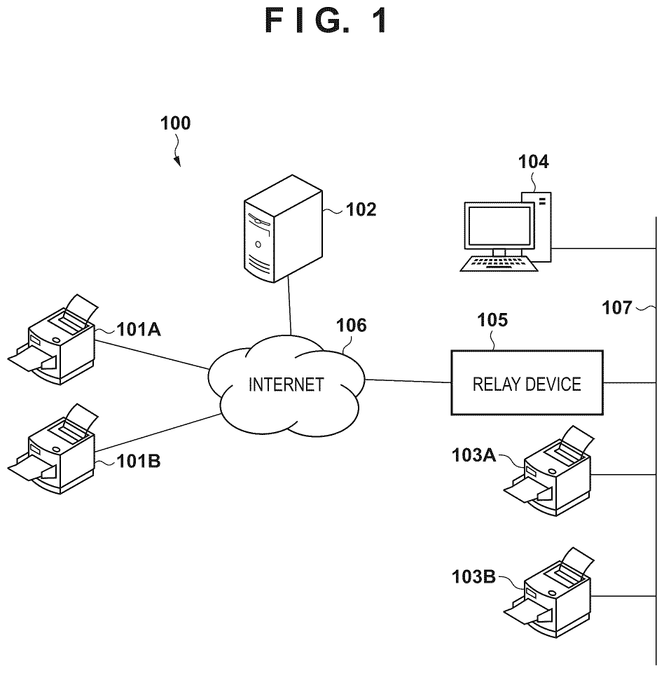

The following describes an exemplary configuration of a printing system 100 according to an embodiment with reference to FIG. 1. The printing system 100 includes printing devices 101A and 101B, a print server 102, printing devices 103A and 103B, and an information processing device 104, for example. The numbers of respective constituent elements of the printing system 100 are not limited to those shown in FIG. 1. Also, the printing system 100 may include a constituent element that is not shown in FIG. 1. The printing system may also be considered to be composed of only some of the constituent elements of the printing system 100.

The information processing device 104, the printing device 103A, and the printing device 103B are connected to the same local area network (LAN) 107. Hereinafter, the printing devices 103A and 103B connected to the same LAN 107 to which the information processing device 104 is connected will be collectively referred to as the printing devices 103. The following description regarding the printing devices 103 applies to both of the printing devices 103A and 103B. The printing devices 103 may also be referred to as local printing devices. The LAN 107 may be a wired LAN, a wireless LAN, or a combination of a wired LAN and a wireless LAN. The printing devices 103 may have a multicast domain name system (mDNS) function for announcing information of the printing devices 103 to all communication devices (e.g., the information processing device 104) connected to the LAN 107. The information processing device 104 may search for the printing devices 103 with use of DNS records including a service (SRV) record, a TXT record, a PTR record, etc., of the mDNS function.

The LAN 107 is connected to the Internet 106 via a relay device 105. The relay device 105 may be a router device, for example. The relay device 105 may function as a firewall. The information processing device 104 and each printing device 103 can communicate with each other in the LAN 107 (i.e., not via the Internet 106). The information processing device 104 can communicate with the print server 102 via the LAN 107, the relay device 105, and the Internet 106. Instead of or in addition to this configuration, the information processing device 104 may also be connected to the Internet 106 via a cellular network (e.g., a network that conforms to the fourth generation communication standards (4G) or the fifth generation communication standards (5G)).

The Internet 106 may be constituted by a combination of a LAN, a wide area network (WAN), a cellular network (e.g., a 4G network or 5G network), a wireless network that conforms to IEEE 802.11, etc., for example. That is to say, any communication scheme may be adopted for the physical layer as long as data can be transmitted and received via the Internet 106.

The printing devices 101A and 101B are each connected to the Internet 106. The print server 102 can communicate with the printing devices 101A and 101B via the Internet 106. Hereinafter, the printing devices 101A and 101B that can communicate with the print server 102 will be collectively referred to as the printing devices 101. The following description regarding the printing devices 101 applies to both of the printing devices 101A and 101B. The printing devices 101 may also be referred to as remote printing devices.

The printing devices 101 and 103 have a print function for performing printing based on a print job. The printing devices 101 and 103 may also have at least one of a scanner function and a fax function in addition to the print function. Printing devices that have a plurality of functions as described above may also be called multifunction peripherals (MFPs). Alternatively, the printing devices 101 and 103 may also be single function peripherals (SFPs) that have only the print function. The term “printing” may refer to printing on a sheet-shaped recording medium such as paper or the formation of a three-dimensional object (so-called 3D printing).

Each printing device 101 may also have a user management function. If the user management function of the printing device 101 is enabled, the printing device 101 requests a user to log in to the printing device 101 to use the functions of the printing device 101. Each printing device 101 may also have a printing suspension function to prevent a printed product from being taken away by a third party or prevent misprinting. The printing suspension function is a function for temporarily storing a print job in a storage and starting printing in accordance with a print instruction given later from a user, rather than immediately starting printing when the print job is received by the printing device 101. If the printing suspension function of the printing device 101 is enabled, the printing device 101 performs printing based on a print job corresponding to a user after the user has successfully logged in to the printing device 101.

The print server 102 provides a printing service in which the print server 102 transmits a print job generated by the information processing device 104 to any of the printing devices 101 (e.g., the printing device 101A) in accordance with the print job. For example, the print server 102 provides a logical printer to the information processing device 104 and accepts a print job for the logical printer. The logical printer is a virtual printing device (e.g., a printer object) provided by the print server 102. The logical printer may also be called a cloud printer. In contrast to the logical printer, physical printing devices such as the printing devices 101 and 103 may also be called physical printers. In the following description, the logical printer and the physical printers will be collectively referred to simply as printers. If a physical printer is connected to the LAN to which the information processing device that gives a print job is also connected, the physical printer may also be called a local printer.

The print server 102 may be a server in an on-premise environment that is connected to the Internet 106 or a server in a cloud computing environment (hereinafter simply referred to as cloud). A printing service provided by the print server 102 that is included in the cloud may also be called a cloud printing service. An example of the cloud printing service is Universal Print (registered trademark) provided by Microsoft Corporation. The following describes a case where the print server 102 is included in the cloud. However, the following description also applies to a case where the print server 102 is included in the on-premise environment.

The print server 102 receives a print job from the information processing device 104 and stores the print job. Thereafter, the print server 102 notifies a printing device 101 that is registered in the print server 102 that the print job has been received. The printing device 101 that has received the notification obtains the print job from the print server 102 and temporarily stores the print job. After a user logs in to the printing device 101, the printing device 101 starts printing corresponding to the print job stored in the printing device 101 in accordance with an instruction from the user.

The information processing device 104 provides a print function to a user of the information processing device 104. The information processing device 104 may be a personal computer (PC), a smartphone, or another device. The information processing device 104 may designate, as an output destination, a physical printer (e.g., the printing device 103A) that is connected to the LAN 107 to which the information processing device 104 is connected or the logical printer provided by the print server 102. If the logical printer is designated as the output destination, a physical printer (e.g., the printing device 101A) associated with the logical printer performs printing. The information processing device 104 that uses the cloud printing service may also be called a client or a client terminal. Printing performed by inputting a print job to the logical printer may also be called cloud printing or remote printing. Printing performed by inputting a print job directly to a physical printer (i.e., in the LAN) may also be called local printing.

### Exemplary Hardware Configuration of Printing Device

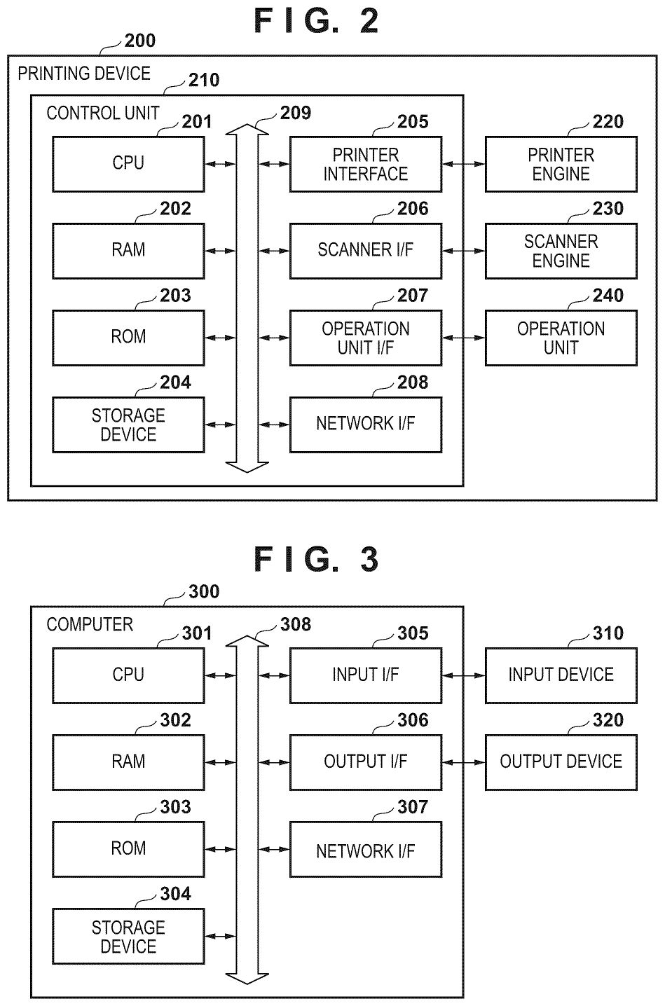

The following describes an exemplary hardware configuration of a printing device 200 according to an embodiment with reference to FIG. 2. The printing device 200 may be used as any of the printing devices 101 and 103. That is to say, the printing device 200 may function as a local printer or a cloud printer. The printing device 200 may also function as both a local printer and a cloud printer for the information processing device 104. The printing device 200 may include constituent elements shown in FIG. 2, but some of the constituent elements may be omitted, or another constituent element may also be included in the printing device 200. The printing device 200 is a physical printing device, and accordingly, may also be called a physical printer.

A central processing unit (CPU) 201 is a general-purpose processing circuit that controls actions of the entire printing device 200. A random-access memory (RAM) 202 is a volatile memory circuit and is used as a temporary storage region such as a work area for processing performed by the CPU 201. A read only memory (ROM) 203 is a non-volatile memory circuit and stores programs and data used in processing performed by the CPU 201. A storage device 204 is a non-volatile storage device and stores programs and data (e.g., a print job, image data, and setting information) used in processing performed by the CPU 201. The storage device 204 may be a hard disk drive (HDD) or a solid state drive (SSD), for example. The storage device 204 may also be called a secondary storage device. Actions of the printing device 200 may be realized by the CPU 201 by executing a program read from the storage device 204 into the RAM 202. Alternatively, some or all actions of the printing device 200 may be realized by a dedicated processing circuit such as an application specific integrated circuit (ASIC).

A printer interface (I/F) 205 is an interface for transmitting signals to a printer engine 220 and receiving signals therefrom. The printer engine 220 performs printing based on signals (e.g., an image signal and a print command) supplied from a control unit 210 via the printer I/F 205. The printing may be electrophotographic printing in which toner is transferred to paper and fixed thereon, ink-jet printing in which ink is ejected toward paper, or 3D printing.

A scanner I/F 206 is an interface for transmitting signals to a scanner engine 230 and receiving signals therefrom. The scanner engine 230 supplies a signal (e.g., an image signal) obtained by reading a document to the control unit 210 via the scanner I/F 206. The CPU 201 may process the image signal supplied from the scanner engine 230 and supply the thus obtained recording image signal to the printer engine 220. Also, the CPU 201 may generate image data based on the image signal supplied from the scanner engine 230 and transmit the image data to an external device.

An operation unit I/F 207 is an interface for transmitting signals to an operation unit 240 and receiving signals therefrom. The operation unit 240 is a device that obtains input from a user of the printing device 200 and provides information to the user of the printing device 200. The operation unit 240 may be constituted by a display panel (e.g., a liquid crystal display), a speaker, a touch panel, a keyboard, a button, a touch screen, a light, a lamp, a buzzer, or a combination of any of these, for example. The operation unit 240 may perform output in accordance with a request from the print server 102 or the information processing device 104, e.g., display information on the display panel, light or flash the light or the lamp, sound the buzzer or the like, or give audio notification.

A network I/F 208 is an interface for communicating with devices outside the printing device 200. The control unit 210 is composed of the CPU 201, the RAM 202, the ROM 203, the storage device 204, the printer I/F 205, the scanner I/F 206, the operation unit I/F 207, and the network I/F 208. The constituent elements included in the control unit 210 are each connected to a system bus 209.

### Exemplary Hardware Configuration of Computer

The following describes an exemplary hardware configuration of a computer 300 according to an embodiment with reference to FIG. 3. The computer 300 may be used as the information processing device 104 or the print server 102. The computer 300 may include constituent elements shown in FIG. 3, but some of the constituent elements may be omitted, or another constituent element may also be included in the computer 300.

A CPU 301 is a general-purpose processing circuit that controls actions of the entire computer 300. A RAM 302 is a volatile memory circuit and is used as a temporary storage region such as a work area for processing performed by the CPU 301. A ROM 303 is a non-volatile memory circuit and stores programs and data used in processing performed by the CPU 301. A storage device 304 is a non-volatile storage device and stores programs and data used in processing performed by the CPU 301. The storage device 304 may be an HDD or an SSD, for example. The storage device 304 may also be called a secondary storage device. Actions of the computer 300 may be realized by the CPU 301 by executing a program read from the storage device 304 into the RAM 302. Alternatively, some or all actions of the computer 300 may be realized by a dedicated processing circuit such as an ASIC.

An input I/F 305 is an interface for transmitting signals to an input device 310 and receiving signals therefrom. The input device 310 is a device that obtains input from a user of the computer 300. The input device 310 may be a keyboard, a touch panel, a microphone, a mouse, or a combination of any of these, for example. An output I/F 306 is an interface for transmitting signals to an output device 320 and receiving signals therefrom. The output device 320 is a device that provides information to the user of the computer 300. The output device 320 may be a display, a speaker, or a combination of these, for example. A network I/F 307 is an interface for communicating with devices outside the computer 300. The CPU 301, the RAM 302, the ROM 303, the storage device 304, the input I/F 305, the output I/F 306, and the network I/F 307 are each connected to a system bus 308. In the example shown in FIG. 3, the input device 310 and the output device 320 are shown as devices separate from the computer 300. Alternatively, the computer 300 may include the input device 310 and the output device 320.

### Identification Action Settings in Printing Device

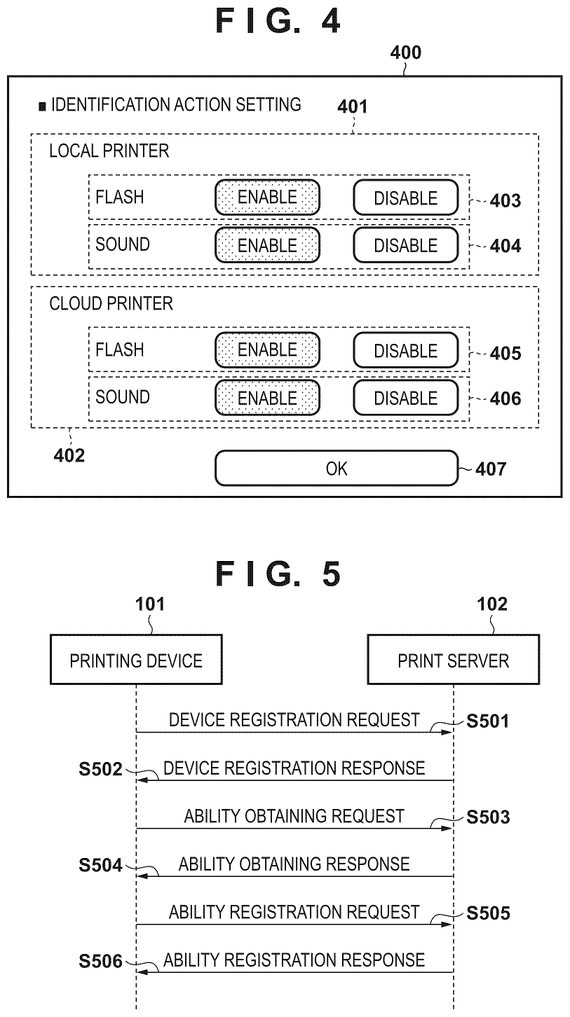

The following describes a method for performing setting relating to an identification action of the printing device 200 with reference to FIG. 4. The printing device 200 may be a printing device 101 or a printing device 103. The identification action of the printing device 200 may be an action for assisting a user of the printing device 200 in identifying the printing device 200. For example, the identification action may be an action for outputting visual information from the printing device 200, an action for outputting audio information from the printing device 200, or an action for outputting both visual information and audio information from the printing device 200. Visual information may be output by displaying a message on the operation unit 240 of the printing device 200. Such an identification action is defined as “display” in the Internet Printing Protocol (IPP). Visual information may be output by flashing or lighting a light or a lamp included in the printing device 200. Such an identification action is defined as “flash” in the IPP. Audio information may be output by sounding a speaker or a buzzer included in the printing device 200 (e.g., outputting a beep sound). Such an identification action is defined as “sound” in the IPP. Audio information may be output by reproducing a predetermined message from the speaker included in the printing device 200. Such an identification action is defined as “speak” in the IPP. The printing device 200 may be capable of executing a plurality of types of identification actions. For example, the printing device 200 may be capable of executing flash and sound. The printing device 200 may execute the identification action in response to a request from the information processing device 104 or the print server 102 as described later.

A setting screen 400 shown in FIG. 4 is a screen for obtaining an instruction relating to settings of the identification action of the printing device 200 from the user. The printing device 200 displays the setting screen 400 on the operation unit 240 and obtains a user operation performed on the setting screen 400. In the example of the setting screen 400, the printing device 200 is capable of executing flash and sound. Alternatively, the printing device 200 may be capable of executing another type of identification action or may be capable of executing only one type of identification action.

The setting screen 400 includes a region 401 and a region 402. The region 401 is a region for obtaining a user instruction relating to settings of the identification action in the case where the printing device 200 functions as a local printer. The region 402 is a region for obtaining a user instruction relating to settings of the identification action in the case where the printing device 200 functions as a cloud printer. The printing device 200 can obtain user instructions independently for the case where the printing device 200 functions as a local printer and the case where the printing device 200 functions as a cloud printer, with use of the setting screen 400. Alternatively, the printing device 200 may obtain a common user instruction for the case where the printing device 200 functions as a local printer and the case where the printing device 200 functions as a cloud printer.

The region 401 includes a region 403 for obtaining a user instruction relating to a setting of flash, and a region 404 for obtaining a user instruction relating to a setting of sound. The region 402 includes a region 405 for obtaining a user instruction relating to a setting of flash, and a region 406 for obtaining a user instruction relating to a setting of sound. The region 403 may include a label showing the type of the identification action, a button for obtaining a user instruction to enable the identification action, and a button for obtaining a user instruction to disable the identification action. The two buttons included in the region 403 may be alternatively selectable. A graphic object other than the buttons (e.g., a check box or a pull-down list) may also be used to obtain user instructions. Each of the regions 404 to 406 may have a configuration similar to the configuration of the region 403. In response to a button 407 being pressed by the user in a state where “enable” or “disable” is selected in the regions 403 to 406, the printing device 200 stores settings in the regions 403 to 406 (i.e., whether the respective identification actions are enabled or disabled) in the storage device 204 and uses the settings in actions performed later. The printing device 200 can obtain user instructions individually for the plurality of identification actions that can be executed, with use of the setting screen 400. Alternatively, the printing device 200 may obtain a common user instruction for the plurality of identification actions that can be executed.

If a specific type of identification action (e.g., flash) is enabled, the printing device 200 may execute the identification action in accordance with a request from an external device (e.g., the print server 102 or the information processing device 104, the same applies hereinafter). Also, if a specific type of identification action is enabled, the printing device 200 may notify the external device that the printing device 200 can execute the identification action. If a specific type of identification action is disabled, the printing device 200 may reject execution of the identification action requested from the external device. Also, if a specific type of identification action is disabled, the printing device 200 may be configured so as not to notify the external device that the printing device 200 can execute the identification action. For example, the printing device 200 may notify the external device that the printing device 200 cannot execute the identification action or notify the external device of nothing about this identification action.

If it is prescribed that a specific type of identification action is not executed in a default state, the printing device 200 may prevent a button for enabling the identification action from being selected. For example, the printing device 200 may hide or gray out the button for enabling the identification action so that the button cannot be selected.

### Printing Device Registration Action

The following describes actions for registering a printing device 101 in the print server 102 with reference to FIG. 5. The actions shown in FIG. 5 may be started in response to a user of the printing device 101 giving an instruction to start registration of the printing device 101 with use of the operation unit 240 of the printing device 101, for example. Once the printing device 101 is registered in the print server 102, the printing device 101 can be used as a cloud printer by the information processing device 104. Actions of the printing device 101 may be realized by the CPU 201 of the printing device 101 by executing a program read into the RAM 202 of the printing device 101, for example. Actions of the print server 102 may be realized by the CPU 301 of the print server 102 by executing a program read into the RAM 302 of the print server 102, for example. An action that is not shown in FIG. 5 may also be executed to register the printing device 101 in the print server 102.

In step S501, the printing device 101 transmits a device registration request to the print server 102. The device registration request may be a request for the print server 102 to register the printing device 101. The destination of the device registration request, which is the print server 102, may be designated by the user. In step S502, the print server 102 processes the device registration request and transmits a device registration response to the printing device 101. The device registration response may be a response to the device registration request.

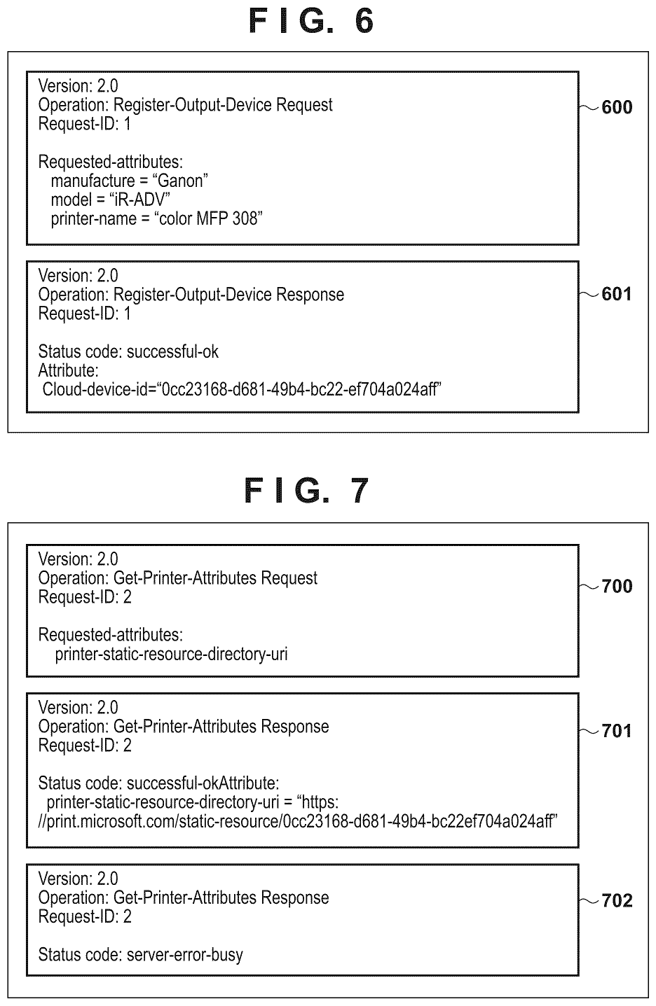

The device registration request and the device registration response may be transmitted with use of packets that conform to the IPP. Examples of such packets will be described with reference to FIG. 6. A packet 600 is an example of a packet that is transmitted as the device registration request. The packet 600 includes operation information and attribute information. The operation information is information indicating the content of an executed operation. The attribute information is information indicating attributes relating to the executed operation. The same also applies to operation information and attribute information of other packets described later. In the packet 600, the operation information is represented by “Operation”. The operation information included in the packet 600 has a value indicating that the executed operation is the device registration request. In the packet 600, the attribute information is represented by “Requested-attributes”. The attribute information included in the packet 600 includes manufacturer information and model information. The attribute information may vary for each printing device 101 that transmits the packet 600.

A packet 601 is an example of a packet that is transmitted as the device registration response to the packet 600. The packet 601 includes operation information, status information, and attribute information. The status information is information indicating the status of an executed operation. The same also applies to status information of other packets described later. In the packet 601, the operation information is represented by “Operation”. The operation information included in the packet 601 has a value indicating that the executed operation is the device registration response. In the packet 601, the status information is represented by “Status Code”. The status information included in the packet 601 has a value indicating that the printing device 101 that has transmitted the device registration request has been successfully registered. If the print server 102 succeeded in registering the printing device 101 in response to the device registration request, the print server 102 transmits a device registration response having such a value to the printing device 101. In the packet 601, the attribute information is represented by “Attribute”. The attribute information included in the packet 601 includes identification information issued to the printing device 101 by the print server 102. The identification information may vary for each printing device 101 that is registered in the print server 102.

In step S503, the printing device 101 transmits an ability obtaining request to the print server 102. The ability obtaining request may be a request to obtain ability information registered in the print server 102 with respect to the printing device 101 from the print server 102. The destination of the ability obtaining request, which is the print server 102, may be the print server 102 in which the printing device 101 has been registered. In step S504, the print server 102 processes the ability obtaining request and transmits an ability obtaining response to the printing device 101. The ability obtaining response may be a response to the ability obtaining request. The ability obtaining response may indicate the ability information registered in the print server 102 with respect to the printing device 101.

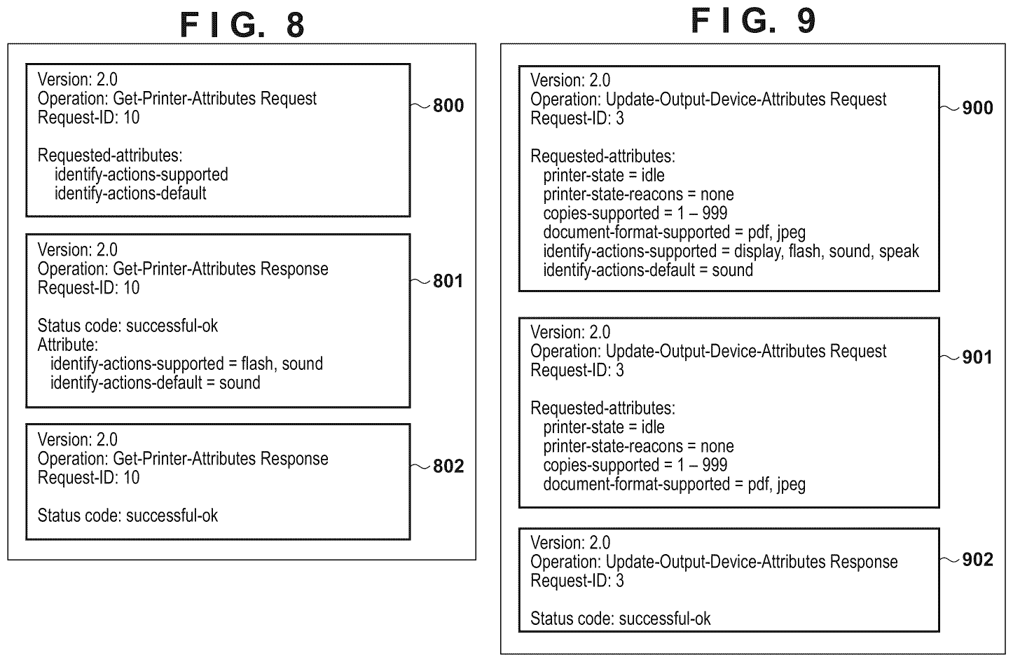

The ability obtaining request and the ability obtaining response may be transmitted with use of packets that conform to the IPP. Examples of such packets will be described with reference to FIGS. 7 and 8. A packet 700 is an example of a packet that is transmitted as the ability obtaining request. The packet 700 includes operation information and attribute information. In the packet 700, the operation information is represented by “Operation”. The operation information included in the packet 700 has a value indicating that the executed operation is the ability obtaining request. In the packet 700, the attribute information is represented by “Requested-attributes”. The attribute information included in the packet 700 has a value indicating that what is requested is URI information indicating the location where the ability information of the printing device 101 is stored.

A packet 701 is an example of a packet that is transmitted as the ability obtaining response to the packet 700. The packet 701 includes operation information, status information, and attribute information. In the packet 701, the operation information is represented by “Operation”. The operation information included in the packet 701 has a value indicating that the executed operation is the ability obtaining response. In the packet 701, the status information is represented by “Status Code”. The status information included in the packet 701 has a value indicating that the ability information of the printing device 101 that has transmitted the ability obtaining request has been successfully obtained. If the print server 102 succeeded in obtaining the ability information of the printing device 101 in response to the ability obtaining request, the print server 102 transmits an ability obtaining response having such a value to the printing device 101. In the packet 701, the attribute information is represented by “Attribute”. The attribute information included in the packet 701 includes the URI information indicating the location where the ability information of the printing device 101 is stored. If the ability information registered with respect to the printing device 101 does not include the URI information, the print server 102 need not include the URI information in the attribute information of the ability obtaining response.

A packet 702 is another example of a packet that is transmitted as the ability obtaining response to the packet 700. The packet 702 includes operation information and status information. The packet 702 differs from the packet 701 in the status information. The status information included in the packet 702 has a value indicating a failure to obtain the ability information of the printing device 101 that has transmitted the ability obtaining request and the reason for the failure. If the print server 102 failed to obtain the ability information of the printing device 101 in response to the ability obtaining request, the print server 102 transmits an ability obtaining response having such a value to the printing device 101.

A packet 800 is another example of a packet that is transmitted as the ability obtaining request. The packet 800 includes operation information and attribute information. The packet 800 differs from the packet 700 in the attribute information. The attribute information included in the packet 800 has a value indicating that what is requested is information indicating types of identification actions that can be executed by the printing device 101 and a default identification action.

A packet 801 is an example of a packet that is transmitted as the ability obtaining response to the packet 800. The packet 801 includes operation information, status information, and attribute information. The packet 801 differs from the packet 701 in the attribute information. The attribute information included in the packet 801 has a value indicating the types of identification actions that can be executed by the printing device 101 and the default identification action. The attribute information included in the packet 801 indicates that the printing device 101 can execute flash and sound, and the default identification action is sound.

A packet 802 is another example of a packet that is transmitted as the ability obtaining response to the packet 800. The packet 802 includes operation information and status information. The packet 802 differs from the packet 701 in that the packet 802 does not include the attribute information. If the print server 102 succeeded in obtaining the ability information of the printing device 101 in response to the ability obtaining request but the ability information does not include information regarding identification actions, the print server 102 transmits an ability obtaining response that does not include attribute information to the printing device 101.

Through the steps S503 and S504 described above, the printing device 101 can confirm whether or not the printing device 101 has been registered in the print server 102 and confirm information of the printing device 101 registered in the print server 102. The printing device 101 may use another method for the confirmation.

In step S505, the printing device 101 transmits an ability registration request to the print server 102. The ability registration request may be a request to register the ability of the printing device 101 in the print server 102. The destination of the ability registration request, which is the print server 102, may be the print server 102 in which the printing device 101 has been registered. In step S506, the print server 102 processes the ability registration request and transmits an ability registration response to the printing device 101. The ability registration response may be a response to the ability registration request.

The ability registration request and the ability registration response may be transmitted with use of packets that conform to the IPP. Examples of such packets will be described with reference to FIG. 9. A packet 900 is an example of a packet that is transmitted as the ability registration request. The packet 900 includes operation information and attribute information. In the packet 900, the operation information is represented by “Operation”. The operation information included in the packet 900 has a value indicating that the executed operation is the ability registration request. In the packet 900, the attribute information is represented by “Requested-attributes”. The attribute information included in the packet 900 includes ability information that is to be registered by the printing device 101 in the print server 102.

The attribute information included in the packet 900 includes an attribute value “identify-actions-supported”. This attribute value indicates types of identification actions that can be executed by the printing device 101. For example, the printing device 101 includes, in this attribute value, types of enabled identification actions among identification actions supported by the printing device 101. The packet 900 indicates that the printing device 101 can execute display, flash, sound, and speak, for example. If the printing device 101 can execute only flash and sound, this attribute value is “flash, sound”. The attribute information included in the packet 900 includes an attribute value “identify-actions-default”. This attribute value indicates a default (e.g., recommended) identification action. The printing device 101 determines the identification actions included in the attribute values “identify-actions-supported” and “identify-actions-default” in accordance with settings designated by the user with use of the setting screen 400 and stored in the storage device 304, for example. If the printing device 101 does not obtain designation from the user to enable or disable identification actions, the printing device 101 may include all identification actions supported by the printing device 101 in the attribute information of the ability registration request.

A packet 901 is another example of a packet that is transmitted as the ability registration request. The packet 901 includes operation information and attribute information. The packet 901 differs from the packet 900 in the attribute information. The attribute information included in the packet 901 does not include the attribute values “identify-actions-supported” and “identify-actions-default”. If there is no enabled identification action or no identification action is supported, the print server 102 transmits such an ability registration request to the printing device 101.

Upon receiving the ability registration request, the print server 102 stores ability information included in the ability registration request in the storage device 304 in association with the printing device 101 that has transmitted the ability registration request. This ability information may also be transmitted to the information processing device 104 in response to a request from the information processing device 104 as described later.

A packet 902 is an example of a packet that is transmitted as the ability registration response to the packets 900 and 901. The packet 902 includes operation information and status information. In the packet 902, the operation information is represented by “Operation”. The operation information included in the packet 902 has a value indicating that the executed operation is the ability registration response. In the packet 902, the status information is represented by “Status Code”. The status information included in the packet 902 has a value indicating that the ability information of the printing device 101 that has transmitted the ability registration request has been successfully registered. If the print server 102 succeeded in registering the ability information of the printing device 101 in response to the ability registration request, the print server 102 transmits an ability registration response having such a value to the printing device 101. On the other hand, if the print server 102 failed to register the ability information of the printing device 101 in response to the ability registration request, the print server 102 may transmit an ability registration response having a value indicating the failure to the printing device 101.

The printing device 101 may execute step S505 again in response to a change in the ability information of the printing device 101, e.g., if settings regarding the identification actions are changed with use of the setting screen 400, for example. Thus, the ability information of the printing device 101 stored in the print server 102 is updated.

### Printing Device Registration Action

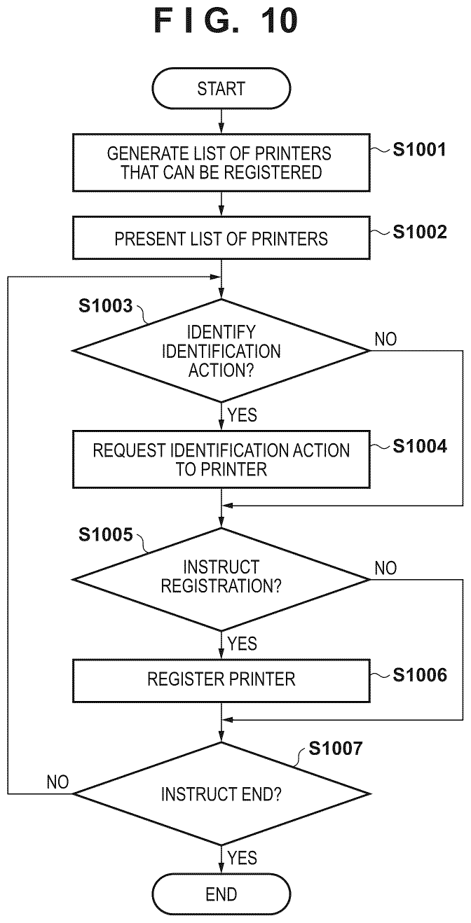

The following describes actions performed by the information processing device 104 to search for printers that can be registered in the information processing device 104 and register a printer designated by the user in the information processing device 104 with reference to FIG. 10. The actions shown in FIG. 10 may be started in response to an instruction given from the user of the information processing device 104 with use of the input device 310 of the information processing device 104 to start a search for printers, for example. A printer that is registered in the information processing device 104 can be used by the information processing device 104. The actions of the information processing device 104 may be realized by the CPU 301 of the information processing device 104 by executing a program read into the RAM 302 of the information processing device 104, for example. An action that is not shown in FIG. 10 may also be executed to register a printer in the information processing device 104.

In step S1001, the information processing device 104 searches for printers that can be registered in the information processing device 104 and generates a list including information of found printers. The information processing device 104 may search for only local printers, only cloud printers, or both local printers and cloud printers. The type of printers to be searched for may be designated by the user or set in the information processing device 104 in advance. In the case where the information processing device 104 searches for both local printers and cloud printers, the information processing device 104 may search for either local printers or cloud printers first, or may search for local printers and cloud printers in parallel.

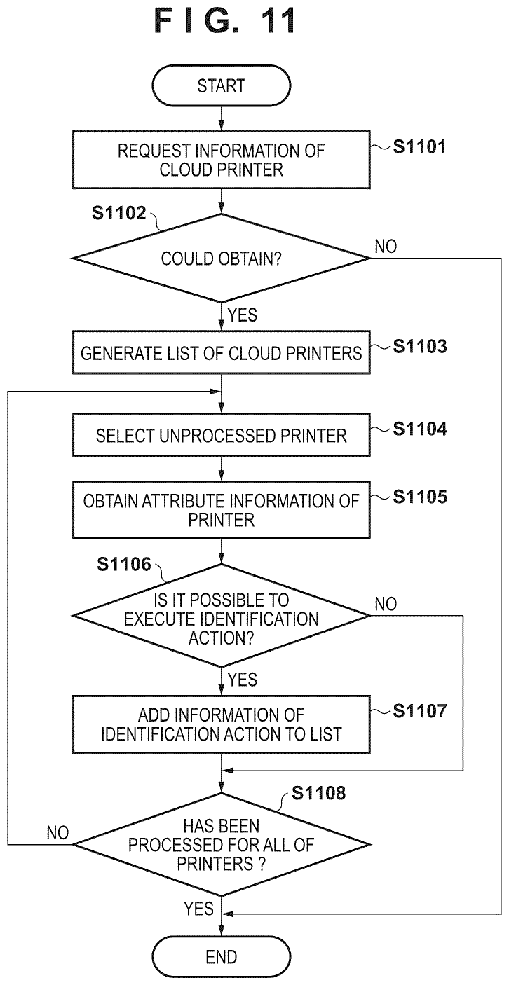

The following describes a method with which the information processing device 104 searches for cloud printers that can be registered in the information processing device 104 and generates a list including information of found cloud printers with reference to FIG. 11. As described above, cloud printers may be the printing devices 101 registered in the print server 102. The method shown in FIG. 11 may be executed as a part of step S1001.

In step S1101, the information processing device 104 requests the print server 102 to provide information of cloud printers that can be registered in the information processing device 104. In response to this request, the print server 102 provides information of cloud printers that can be registered in the information processing device 104. The cloud printers that can be registered in the information processing device 104 may be all printers registered in the print server 102. Alternatively, the cloud printers that can be registered in the information processing device 104 may be printers for which the information processing device 104 has the right to use, among printers registered in the print server 102.

In step S1102, the information processing device 104 determines whether or not information of cloud printers has been obtained. Upon determining that information of cloud printers has been obtained (YES in step S1102), the information processing device 104 proceeds to step S1103, otherwise (NO in step S1102) ends the processing.

In step S1103, the information processing device 104 generates a list including the information of cloud printers obtained from the print server 102. If a cloud printer whose information has been obtained from the print server 102 has already been registered in the information processing device 104, the information processing device 104 need not include the cloud printer in the list.

In step S1104, the information processing device 104 selects one cloud printer for which processing in the following steps S1105 to S1107 has not been performed, from the cloud printers included in the list generated in step S1103. In step S1105, the information processing device 104 obtains attribute information of the selected cloud printer. The attribute information may be obtained by transmitting and receiving packets that conform to the IPP. The attribute information of the cloud printer may include ability information of the cloud printer. If the cloud printer can execute an identification action, the ability information of the cloud printer may include the type of the identification action that can be executed by the cloud printer.

In step S1106, the information processing device 104 determines whether or not the selected cloud printer can execute an identification action. Upon determining that the selected cloud printer can execute an identification action (YES in step S1106), the information processing device 104 proceeds to step S1107, otherwise (NO in step S1106) proceeds to step S1108.

If the attribute information indicating supported operation information (operations-supported) of the cloud printer includes information of an identification action (identify-actions-supported), the information processing device 104 may determine that the cloud printer can execute the identification action. If the attribute information indicating supported operation information (operations-supported) of the cloud printer does not include information of an identification action (identify-actions-supported), the information processing device 104 may determine that the cloud printer cannot execute the identification action. If a printing device 101 supports an identification action and the identification action is enabled, it is determined that a cloud printer associated with the printing device 101 can execute the identification action. If the printing device 101 does not support an identification action or the printing device 101 supports the identification action but the identification action is disabled, it is determined that the cloud printer associated with the printing device 101 cannot execute the identification action.

In step S1107, the information processing device 104 adds information indicating the type of the identification action that can be executed by the selected cloud printer to the list.

In step S1108, the information processing device 104 determines whether or not the processing in steps S1105 to S1107 has been executed for all of the cloud printers included in the list generated in step S1103. Upon determining that the processing has been executed for all of the cloud printers (YES in step S1108), the information processing device 104 ends the processing, otherwise (NO in step S1108) returns to step S1104.

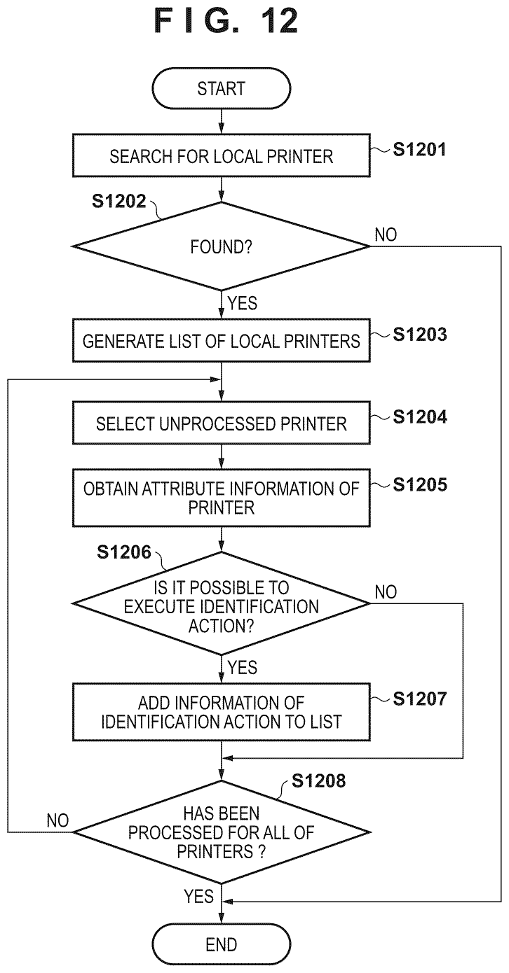

The following describes a method with which the information processing device 104 searches for local printers that can be registered in the information processing device 104 and generates a list including information of found local printers with reference to FIG. 12. The method shown in FIG. 12 may be executed as a part of step S1001.

In step S1201, the information processing device 104 searches for local printers that are connected to the LAN 107 to which the information processing device 104 is connected, with use of mDNS. In step S1202, the information processing device 104 determines whether or not local printers have been found. Upon determining that local printers have been found (YES in step S1202), the information processing device 104 proceeds to step S1203, otherwise (NO in step S1202) ends the processing.

In step S1203, the information processing device 104 generates a list including information of the found local printers. If a found local printer has already been registered in the information processing device 104, the information processing device 104 need not include the local printer in the list.

Processing in steps S1204 to S1208 is the same as the processing in steps S1104 to S1108, except that targets of the processing are local printers, and therefore, redundant descriptions thereof are omitted.

Referring back to FIG. 10, in step S1002, the information processing device 104 presents to the user a screen including the list of printers that can be registered. The list of printers that can be registered may be a combination of a list of cloud printers generated based on a search result obtained through the actions shown in FIG. 11 and a list of local printers generated based on a search result obtained through the actions shown in FIG. 12. The list need not include printers that have already been registered in the information processing device

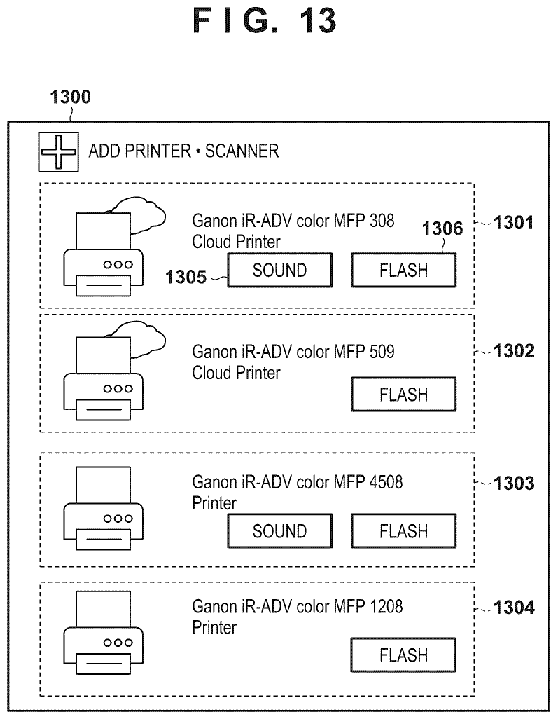

The following describes an example of a registration screen 1300 including the list of printers that can be registered in the information processing device 104 with reference to FIG. 13. The information processing device 104 displays the registration screen 1300 on the output device 320 (e.g., a display) of the information processing device 104 and obtains a user operation performed on the registration screen 1300 with use of the input device 310. The registration screen 1300 may also be used to obtain an instruction from the user to register a printer in the information processing device 104. The registration screen 1300 may also be used to obtain an instruction from the user to cause a printer to execute an identification action.

The registration screen 1300 includes regions 1301 to 1304. Each of the regions 1301 to 1304 is a region for displaying information of a printer that can be registered in the information processing device 104 and obtaining a user instruction to the printer.

The information processing device 104 may display information of a cloud printer that is associated with the printing device 101A in the region 1301, for example. The region 1301 includes an icon representing a printer, information of the manufacturer and the model of the printer, a label (“Cloud Printer”) indicating that the printer is a cloud printer, and buttons 1305 and 1306 for obtaining instructions to execute identification actions. The information processing device 104 may register the cloud printer associated with the printing device 101A in response to the icon in the region 1301 being pressed by the user.

In the following description, it is assumed that information of the printing device 101A indicates that the printing device 101A can execute sound and flash as identification actions. In this case, the information processing device 104 presents to the user an indication that the printing device 101A can execute the identification actions. Furthermore, the information processing device 104 presents to the user the types of identification actions that can be executed by the printing device 101A.

Specifically, if the printing device 101A can execute sound, the information processing device 104 may include the button 1305 in the region 1301. The button 1305 is a graphic object for obtaining a user instruction to cause the cloud printer to execute sound as an identification action. The button 1305 is provided with a label “sound”. If the printing device 101A can execute flash, the information processing device 104 may include the button 1306 in the region 1301. The button 1306 is a graphic object for obtaining a user instruction to cause the cloud printer to execute flash as an identification action. The button 1306 is provided with a label “flash”.

As described above, the information processing device 104 presents to the user an indication that the printing device 101A can execute identification actions by including the buttons 1305 and 1306 in the region 1301. Furthermore, the information processing device 104 presents to the user an indication that the printing device 101A can execute the specific type of identification action (in this example, sound) by providing the button 1305 with the label “sound”. Similar can be said for the button 1306.

The region 1302 may show information of a cloud printer associated with the printing device 101B, for example. The region 1302 may be similar to the region 1301, except that the printing device 101B can execute only flash as an identification action.

The region 1303 may show information of the printing device 103A found as a local printer, for example. The region 1303 may include a label (“Printer”) indicating that the printer is a local printer. The other aspects of the region 1303 may be similar to those of the region 1301.

The region 1304 may show information of the printing device 103B found as a local printer, for example. The region 1304 may include the label (“Printer”) indicating that the printer is a local printer. The other aspects of the region 1304 may be similar to those of the region 1302.

Referring back to FIG. 10, in step S1003, the information processing device 104 determines whether or not an instruction to cause a printer to execute an identification action has been obtained from the user. The instruction to cause a printer to execute an identification action will be referred to as an identification action instruction. Upon determining that the identification action instruction has been obtained (YES in step S1003), the information processing device 104 proceeds to step S1004, otherwise (NO in step S1003) proceeds to step S1005. As described above, the identification action instruction can be obtained with use of the buttons 1305, 1306, etc., in the registration screen 1300, for example. The identification action instruction may include designation of a printer that is to execute an identification action and designation of the type of identification action to be executed by the printer. Alternatively, the identification action instruction may include only designation of a printer that is to execute an identification action, without including designation of the type of identification action to be executed by the printer. In this case, the information processing device 104 may request the designated printer to execute a default identification action. For example, the registration screen 1300 may include a button for obtaining an instruction to cause the printer to execute the default identification action, instead of or in addition to the buttons 1305 and 1306.

In step S1004, the information processing device 104 causes the printer designated by the user to execute the identification action. If the printer designated by the user is a cloud printer, the information processing device 104 requests the print server 102 to cause the printer to execute the identification action. If the printer designated by the user is a local printer, the information processing device 104 requests the printing device 103 functioning as the local printer to execute the identification action.

In step S1005, the information processing device 104 determines whether or not an instruction to register the printer in the information processing device 104 has been obtained from the user. The instruction to register the printer in the information processing device 104 will be referred to as a printer registration instruction. Upon determining that the printer registration instruction has been obtained (YES in step S1005), the information processing device 104 proceeds to step S1006, otherwise (NO in step S1005) proceeds to step S1007. As described above, the printer registration instruction can be obtained with use of an icon of the printer in the registration screen 1300, for example. The printer registration instruction may include designation of the printer to be registered.

In step S1006, the information processing device 104 registers the printer designated by the user in the information processing device 104. Thereafter, the information processing device 104 can input a print job to the registered printer.

In step S1007, the information processing device 104 determines whether or not an instruction to end the registration processing has been obtained from the user. The instruction to end the registration processing will be referred to as a registration end instruction. Upon determining that the registration end instruction has been obtained (YES in step S1007), the information processing device 104 ends the processing, otherwise (NO in step S1007) returns to step S1003.

In the method described above, the information processing device 104 registers one or more printers in the information processing device 104 in response to printer registration instructions until the information processing device 104 obtains the registration end instruction. Alternatively, the information processing device 104 may obtain a printer registration instruction for a printer, and end the method shown in FIG. 10 upon registering the printer.

### Identification Action of Cloud Printer

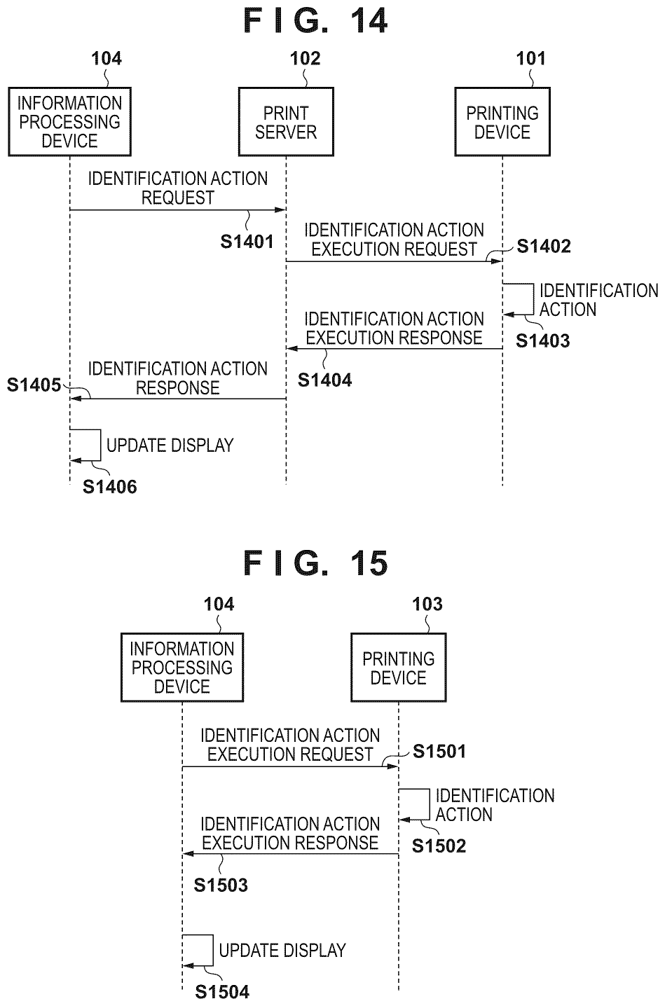

The following describes a method with which the information processing device 104 causes a cloud printer to execute an identification action in step S1004 with reference to FIG. 14. The information processing device 104 executes the method shown in FIG. 14 in the case where the printer designated in the identification action instruction is a cloud printer.

In step S1401, the information processing device 104 transmits to the print server 102 a request to cause the cloud printer to execute an identification action. The request to cause the cloud printer to execute an identification action will be referred to as an identification action request. The identification action request may include designation of the printer that is to execute an identification action and designation of the type of identification action to be executed by the printer. The printer that is to execute an identification action may be a printer designated by the user with use of the registration screen 1300. The type of identification action to be executed by the printer may be a type of identification action designated by the user with use of the registration screen 1300. For example, when the button 1305 is pressed by the user, execution of sound by the printer shown in the region 1301 is designated. If the user has not designated the type of identification action, the information processing device 104 need not include designation of the type of identification action to be executed in the identification action request.

In step S1402, upon receiving the identification action request, the print server 102 transmits a request for execution of the identification action to the printing device 101 associated with the cloud printer designated in the identification action request. The request for execution of the identification action will be referred to as an identification action execution request. The identification action execution request may include designation of the type of identification action to be executed. If the type of identification action to be executed is not designated in the identification action request, the print server 102 need not include designation of the type of identification action to be executed in the identification action execution request.

Upon receiving the identification action execution request, the printing device 101 executes the identification action in step S1403. If the type of identification action is designated in the identification action execution request, the printing device 101 executes the designated identification action. For example, if sound is designated in the identification action execution request, the printing device 101 outputs a sound (e.g., a beep sound) with use of a speaker. If the type of identification action is not designated in the identification action execution request, the printing device 101 executes a default identification action. Thus, the information processing device 104 may cause the printing device 101 to execute a specific type of identification action.

After executing the identification action or failing to execute the identification action, the printing device 101 transmits an identification action execution response to the print server 102 in step S1404 as a response to the identification action execution request. The identification action execution response may include an execution status (success or failure) of the identification action.

After receiving the identification action execution response, the print server 102 transmits an identification action response to the information processing device 104 in step S1405 as a response to the identification action request. The identification action response may include the execution status (success or failure) of the identification action included in the identification action execution response.

If the execution status of the identification action included in the identification action response indicates that the printing device 101 has executed the identification action, the information processing device 104 may present to the user an indication that the identification action has been executed, in step S1406. For example, the information processing device 104 may present to the user an indication that the printing device 101 has executed the identification action by changing the manner of display of a graphic object for obtaining an instruction to cause the printing device 101 to execute the identification action. For example, if the information processing device 104 has received an identification action response that includes a notification indicating that sound was successfully executed after the printing device 101A was caused to execute sound in response to the button 1305 being pressed by the user, the information processing device 104 may change the manner of display of the button 1305. The manner of display of the button 1305 may be changed by causing the button 1305 to flash. This enables the user to recognize that the identification action is executed by the designated printer. Another method may also be used to notify the user that the designated printer has executed the identification action. On the other hand, if the information processing device 104 has received an identification action response that includes a notification indicating a failure to execute the identification action, the information processing device 104 may notify the user of the failure.

After causing the designated printer to execute the identification action, the user confirms that a printer in the vicinity of the user is executing the identification action. After confirming that the printer executing the identification action is the printer that the user wants to register, the user may register the printer. Thus, the user can register the intended printer in the information processing device 104. The printing device 101 may automatically end the identification action after executing the identification action for a predetermined period of time. Alternatively, the printing device 101 may end the identification action in response to an instruction from the user. The instruction from the user may be given via the information processing device 104 or with use of the operation unit 240 of the printing device 101.

### Identification Action of Local Printer

The following describes a method with which the information processing device 104 causes a local printer to execute an identification action in step S1004 with reference to FIG. 15. The information processing device 104 executes the method shown in FIG. 15 in the case where the printer designated in the identification action instruction is a local printer.

In step S1501, the information processing device 104 transmits an identification action execution request to the printing device 103 that operates as the printer designated by the user with use of the registration screen 1300. As described above, the identification action execution request is a request for execution of an identification action. The identification action execution request may include designation of the type of identification action to be executed. The type of identification action to be executed by the printer may be a type of identification action designated by the user with use of the registration screen 1300. If the user has not designated the type of identification action, the information processing device 104 need not include designation of the type of identification action to be executed in the identification action execution request.

In step S1502, the printing device 103 executes the identification action similarly to step S1403. After executing the identification action or failing to execute the identification action, the printing device 103 transmits an identification action execution response to the print server 102 in step S1503 as a response to the identification action execution request. The identification action execution response may include an execution status (success or failure) of the identification action. In step S1504, the information processing device 104 may present to the user an indication that the printing device 103 has executed the identification action similarly to step S1406.

After causing the designated printer to execute the identification action, the user confirms that a printer in the vicinity of the user is executing the identification action. After confirming that the printer executing the identification action is the printer that the user wants to register, the user may register the printer. Thus, the user can register the intended printer in the information processing device 104.

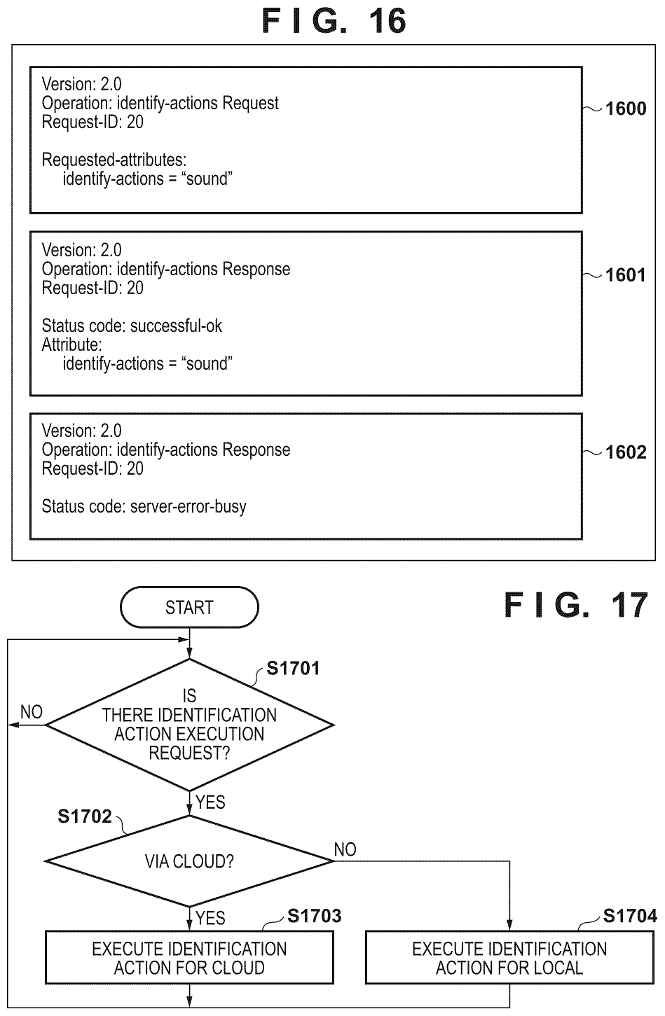

The identification action execution request and the identification action execution response may be transmitted with use of packets that conform to the IPP. Examples of such packets will be described with reference to FIG. 16. A packet 1600 is an example of a packet that is transmitted as the identification action execution request. The packet 1600 includes operation information and attribute information. In the packet 1600, the operation information is represented by “Operation”. The operation information included in the packet 1600 has a value indicating that the executed operation is the identification action execution request. In the packet 1600, the attribute information is represented by “Requested-attributes”. The attribute information included in the packet 1600 includes designation of the type of identification action. Sound is designated in the packet 1600.

A packet 1601 is an example of a packet that is transmitted as the identification action execution response to the packet 1600. The packet 1601 includes operation information, status information, and attribute information. In the packet 1601, the operation information is represented by “Operation”. The operation information included in the packet 1601 has a value indicating that the executed operation is the identification action execution response. In the packet 1601, the status information is represented by “Status Code”. The status information included in the packet 1601 has a value indicating that the identification action has been successfully executed. If the printing device 200 succeeded in executing the identification action, the printing device 200 transmits an identification action execution response having such a value to the information processing device 104 or the print server 102. In the packet 1601, the attribute information is represented by “Attribute”. The attribute information included in the packet 1601 includes the type of executed identification action.

A packet 1602 is another example of a packet that is transmitted as the identification action execution response to the packet 1600. The packet 1602 includes operation information and status information. The packet 1602 differs from the packet 1601 in the status information. The status information included in the packet 1602 has a value indicating a failure to execute the identification action and the reason for the failure. If the printing device 200 failed to execute the identification action, the printing device 200 transmits an identification action execution response having such a value to the information processing device 104 or the print server 102.

As described above, the identification action execution request and the identification action execution response may be transmitted with use of packets that conform to the IPP. Instead of or in addition to the identification action execution request and the identification action execution response, the identification action request and the identification action response may be transmitted with use of packets that conform to the IPP. A packet that is transmitted as the identification action request may be similar to the packet 1600. A packet that is transmitted as the identification action response may be similar to the packet 1601 or 1602.

### Variation of Printing Device Registration Operation

The printing device 200 may execute the same type of identification action (e.g., sound) in the same manner irrespective of whether the printing device 200 has received the identification action execution request from the print server 102 or from the information processing device 104. Alternatively, the printing device 200 may execute the same type of identification action (e.g., sound) in different manners based on whether the printing device 200 has received the identification action execution request from the print server 102 or from the information processing device 104. This method will be described with reference to FIG. 17.

In step S1701, the printing device 200 determines whether or not an identification action execution request has been received. Upon determining that an identification action execution request has been received (YES in step S1701), the printing device 200 proceeds to step S1702, otherwise (NO in step S1701) repeats step S1701. That is to say, the printing device 200 waits for the reception of an identification action execution request.

In step S1702, the printing device 200 determines whether or not the identification action execution request has been received from the print server 102. Upon determining that the identification action execution request has been received from the print server 102 (YES in step S1702), the printing device 200 proceeds to step S1703, otherwise (NO in step S1702) proceeds to step S1704. If it is not determined that the identification action execution request has been received from the print server 102, the identification action execution request has been received from the information processing device 104.

In step S1703, the printing device 200 executes an identification action in accordance with the identification action execution request from the print server 102. In step S1704, the printing device 200 executes an identification action in accordance with the identification action execution request from the information processing device 104. Even if the identification action performed in step S1703 and the identification action performed in step S1704 are the same type of identification action, the identification actions may be performed in different manners. For example, in the case where sound is designated, the printing device 200 may output a sound with a larger sound volume and/or for a longer duration in step S1703 when compared with step S1704. For example, in the case where flash is designated, the printing device 200 may emit light with a higher light intensity, for a longer period of time, at shorter flashing intervals, or with a combination of any of these in step S1703 when compared with step S1704. If an identification action is executed in different manners as described above, the user can easily recognize whether the printing device 200 executing the identification action is operating as a cloud printer or a local printer.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-018846, filed Feb. 9, 2024, which is hereby incorporated by reference herein in its entirety.

What is claimed is:

1. An information processing device comprising:
an obtaining unit configured to obtain information of a printing device that can be registered in the information processing device by searching for one or more printing devices registered in a print server and one or more printing devices connected to a local area network to which the information processing device is connected;
a presentation unit configured to, in a case where the information indicates that the printing device is capable of executing an identification action that assists a user in identifying the printing device, present to the user an indication that the printing device corresponding to the information is capable of executing the identification action;
a request unit configured to cause the printing device to execute the identification action in response to an instruction from the user to cause the printing device selected from one or more presented printing devices to execute the identification action; and
a registration unit configured to register the printing device in the information processing device in response to an instruction from the user to register the printing device in the information processing device.

2. The information processing device according to claim 1,
wherein the presentation unit
generates a list of one or more printing devices that can be registered in the information processing device based on a result of search performed by the obtaining unit,
presents the list to the user, and
with respect to each printing device included in the list, in a case where the information of the printing device indicates that the printing device is capable of executing the identification action, presents to the user an indication that the printing device is capable of executing the identification action.

3. The information processing device according to claim 1,
wherein, in a case where the information of the printing device includes a type of the identification action that can be executed by the printing device, the presentation unit presents to the user the type of the identification action that can be executed by the printing device.

4. The information processing device according to claim 1,
wherein, in response to an instruction from the user to cause the printing device to execute a specific type of the identification action, the request unit causes the printing device to execute the specific type of the identification action.

5. The information processing device according to claim 1,
wherein the identification action includes at least one of outputting audio information from the printing device and outputting visual information from the printing device.

6. The information processing device according to claim 1,
wherein, in a case where the information processing device has received information indicating that the printing device has executed the identification action, the presentation unit presents to the user an indication that the printing device has executed the identification action.

7. The information processing device according to claim 6,
wherein the presentation unit
displays a graphic object for obtaining an instruction to cause the printing device to execute the identification action, and
changes a manner of display of the graphic object to present to the user the indication that the printing device has executed the identification action.

8. The information processing device according to claim 1,
wherein, in a case where the printing device is registered in a print server, the request unit causes the printing device to execute the identification action by requesting the print server to cause the printing device to execute the identification action, and
in a case where the printing device is connected to the local area network to which the information processing device is connected, the request unit causes the printing device to execute the identification action by requesting the printing device to execute the identification action.

9. The information processing device according to claim 1,
wherein the request unit causes the printing device to execute the identification action with use of an Internet printing protocol.

10. The information processing device according to claim 1,
wherein information of a printing device registered in the print server is information registered by the printing device with use of an Internet printing protocol, and
the obtaining unit obtains the information of the printing device registered in the print server with use of the Internet printing protocol, and obtains information of a printing device connected to the local area network with use of a protocol different from the Internet printing protocol.

11. The information processing device according to claim 10,
wherein the protocol different from the Internet printing protocol is a multicast domain name system.

12. A non-transitory computer readable storage medium storing therein a program for causing a computer to function as the information processing device according to claim 1.

13. A method for controlling an information processing device, the method comprising:
obtaining information of a printing device that can be registered in the information processing device by searching for one or more printing devices registered in a print server and one or more printing devices connected to a local area network to which the information processing device is connected;
presenting to a user, in a case where the information indicates that the printing device is capable of executing an identification action that assists the user in identifying the printing device, an indication that the printing device corresponding to the information is capable of executing the identification action;
causing the printing device to execute the identification action in response to an instruction from the user to cause the printing device selected from one or more presented printing devices to execute the identification action; and
registering the printing device in the information processing device in response to an instruction from the user to register the printing device in the information processing device.

14. A printing system comprising:
an information processing device; and
a printing device,
wherein the printing device includes an execution unit configured to execute an identification action that assists a user in identifying the printing device, and
the information processing device includes:
an obtaining unit configured to obtain information of a printing device that can be registered in the information processing device by searching for one or more printing devices registered in a print server and one or more printing devices connected to a local area network to which the information processing device is connected;
a presentation unit configured to, in a case where the information indicates that the printing device is capable of executing the identification action, present to the user an indication that the printing device corresponding to the information is capable of executing the identification action;
a request unit configured to cause the printing device to execute the identification action in response to an instruction from the user to cause the printing device selected from one or more presented printing devices to execute the identification action; and
a registration unit configured to register the printing device in the information processing device in response to an instruction from the user to register the printing device in the information processing device.

15. The printing system according to claim 14,
wherein the execution unit executes the identification action in respective different manners in a case where execution of the identification action is requested by a print server and a case where execution of the identification action is requested by the information processing device.
